(19) United States
(12) Patent Application Publication
(10) Pub. No.: US 2020/0141606 A1
(43) Pub. Date: May 7, 2020

(54) HVAC INDOOR BLOWER COMISSIONING TO MATCH DUCTED APPLICATION USING A SMART DEVICE

(71) Applicant: Carrier Corporation, Palm Beach Gardens, FL (US)

(72) Inventors: Eric E. Tournier, Zionsville, IN (US); Mark J. Ladd, Indianapolis, IN (US)

(21) Appl. No.: 16/620,377

(22) PCT Filed: Jun. 7, 2018
(86) PCT No.: PCT/US2018/036481

§ 371 Date: Dec. 9, 2019

Related U.S. Application Data
(60) Provisional application No. 62/517,427, filed on Jun. 9, 2017.

(51) Int. Cl. F24F 11/49; F24F 3/044; F24F 11/64; F24F 11/77; F04D 27/00; G05B 19/042

(52) U.S. Cl. CPC F24F 11/49; F24F 3/044; F24F 11/64; F24F 11/77; G05B 2219/2614; G05B 19/042; F05D 2270/335; F05D 2270/3061; F04D 27/001

(57) ABSTRACT

A method for commissioning an air handler including a blower and a motor to match a ducted application in a heating, ventilation, and cooling (HVAC) system. The method including obtaining product and operational information regarding at least the motor and the blower, communicating a commanded torque to the motor, and operating the motor at the commanded torque. The method also includes receiving a motor signal indicative of an operating characteristic of the motor, determining at least an operational air flow based on at least the commanded torque, the operating characteristic, and the operational information, comparing an operational air flow to a desired airflow for a particular configuration of the HVAC system based on the operational information, and identifying and communicating a new commanded torque to the motor if the difference between the operational airflow and the desired airflow exceeds a selected tolerance.

### FIELD OF INVENTION

Embodiments relate generally to air flow control in an HVAC system and, more particularly, to a system and method for improved air flow control algorithms in an indoor air handling unit of a ducted HVAC system that provides more accurate air flow control over the full operating range of the air handler and potentially eliminates external measurement of the air flow for commissioning or diagnosis. Embodiments include a method for computing airflow of an indoor blower motor without utilizing external power measuring devices and for establishing an ideal a torque correction to achieve a desired airflow.

### DESCRIPTION OF RELATED ART

Modern structures, such as office buildings and residences, utilize heating, ventilation, and cooling (HVAC) systems having controllers that allow users to control the environmental conditions within these structures. These controllers have evolved over time from simple temperature based controllers to more advanced programmable controllers, which allow users to program a schedule of temperature set points in one or more environmental control zones for a fixed number of time periods as well as to control the humidity in the control zones, or other similar conditions. Typically, these HVAC systems use an air handler connected to ducts to delivered conditioned air to an interior space. These ducts provide a path for air to be drawn from the conditioned space and then returned to the air handler. These duct systems vary in shape, cross section and length to serve the design constraints of a structure. The air handler includes a motor and a fan to move the air through the ducts, conditioning equipment and the space. These air handlers are designed to accommodate the wide range of loading represented by the various duct system designs used in these modern structures.

Some current air handlers use electronically commutated motors (ECM) with internal compensation algorithms that improve the blower system performance over induction motor driven models. The algorithms in these ECM driven blowers are capable of varying power output to provide improved blower performance to meet loading requirements over most of the air handler's operating envelope of mass flow versus static pressure loading. However for some systems with less sophisticated and less expensive motors matching blower motors to the application to achieve a desired airflow is not readily available.

### BRIEF SUMMARY

Described herein in an embodiment is a method for commissioning an air handler including a blower and a motor to match a ducted application in a heating, ventilation, and cooling (HVAC) system. The method including obtaining product and operational information regarding at least the motor and the blower, communicating a commanded torque to the motor, and operating the motor at the commanded torque. The method also includes receiving a motor signal indicative of an operating characteristic of the motor, determining at least an operational air flow based on at least the commanded torque, the operating characteristic, and the operational information, comparing an operational air flow to a desired airflow for a particular configuration of the HVAC system based on the operational information, and identifying and communicating a new commanded torque to the motor if the difference between the operational airflow and the desired airflow exceeds a selected tolerance.

In addition to one or more of the features described above, or as an alternative, further embodiments may include iteratively repeating the communicating a commanded torque, operating, receiving, determining, comparing, and identifying steps periodically if the difference between the operational airflow and the desired airflow exceeds the specified tolerance.

In addition to one or more of the features described above, or as an alternative, further embodiments may include that communicating with the motor includes transmitting and receiving information via a user device on at least one of a motor control bus, a system control bus, a wired system network, and a wireless system network.

In addition to one or more of the features described above, or as an alternative, further embodiments may include that the torque command is transmitted via at least one of an air handler controller in operable communication with at least one of the motor, the user device, and the system control unit; a user device in operable communication with at least one of the motor, the air handler controller and the system controller; and a system control unit in operable communication with at least one of the air handler controller, the user device, and the motor.

In addition to one or more of the features described above, or as an alternative, further embodiments may include that the obtaining product and operational information includes at least one of: type of motor, type of blower, motor model, blower model, motor size, motor operational constraints, and blower operational constraints.

In addition to one or more of the features described above, or as an alternative, further embodiments may include that the receiving a motor signal comprises receiving the signal at a user device in operable communication with at least one of the system controller, the air handler controller, and the motor.

In addition to one or more of the features described above, or as an alternative, further embodiments may include that the operating characteristic is indicative of the rotational speed of the motor.

In addition to one or more of the features described above, or as an alternative, further embodiments may include displaying at least one of the operating characteristic and operational information of the motor.

In addition to one or more of the features described above, or as an alternative, further embodiments may include that the determining the operational air flow is identified by at least one of a signal provided by the motor, a look up table, and equation or formula.

In addition to one or more of the features described above, or as an alternative, further embodiments may include that the determining the operational air flow includes comparing the operational airflow to expected parameters to provide a certification of the air handler.

In addition to one or more of the features described above, or as an alternative, further embodiments may include that the desired airflow is based on previously established testing and empirical data for a given air handler configuration.

In addition to one or more of the features described above, or as an alternative, further embodiments may include that the selected tolerance is at least one of: of +/−10% of the target airflow, +/−7% of target airflow, +/−5% of target airflow, +/−2% of target airflow, and +/−1% of target airflow.

Also disclosed herein in another exemplary embodiment is a system for commissioning an air handler to match a ducted application in a heating, ventilation, and cooling (HVAC) system. The system includes an air handler including an indoor blower and a motor operably coupled to a duct network, the motor configured to operate at a preset torque, and a user device in operable communication with the motor, the user device configured to execute a method for commissioning the air handler. The method including obtaining product and operational information regarding the HVAC system components including the motor and the blower, communicating a commanded torque to the motor, operating the motor at the commanded torque, receiving a motor signal indicative of an operating characteristic of the motor, determining at least an operational air flow based on at least the commanded torque, the operating characteristic, and the operational information, comparing an operational air flow to a desired airflow for a particular configuration of the HVAC system based on the operational information, and identifying and communicating a new commanded torque to the motor if the difference between the operational airflow and the desired airflow exceeds a specified or predetermined tolerance.

In addition to one or more of the features described above, or as an alternative, further embodiments may include at least one of an air handler controller in operable communication with at least one of the motor and the user device, the air handler controller configured to provide control commands to operate the motor; and a system control unit, the system control unit in operable communication with at least one of the motor, the air handler control unit, and the user device.

In addition to one or more of the features described above, or as an alternative, further embodiments may include that the torque command being transmitted via at least one of an air handler controller in operable communication with the motor, and a system control unit in operable communication with at least one of the air handler controller and the motor.

In addition to one or more of the features described above, or as an alternative, further embodiments may include that the user device communicating with the motor via a on at least one of a motor control bus, a system control bus, a wired system network, and a wireless system network.

In addition to one or more of the features described above, or as an alternative, further embodiments may include displaying at least one of the operating characteristic and operational information of the motor.

In addition to one or more of the features described above, or as an alternative, further embodiments may include that the determining the operational air flow is identified by at least one of a signal provided by the motor, a look up table, and equation or formula.

In addition to one or more of the features described above, or as an alternative, further embodiments may include that the determining the operational air flow includes comparing the operational airflow to expected parameters to provide a certification of the air handler.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which

FIG. 1 illustrates a schematic view of an HVAC system including an air handler, system control unit, an air handler control unit, and a user device for implementing the method in accordance with an embodiment; and

FIG. 2 is a flow diagram illustrating a method for commissioning an air handler including a blower and a motor to match a ducted application in a heating, ventilation, and cooling (HVAC) system in accordance with an embodiment.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in Figure X may be labeled “Xa” and a similar feature in Figure Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Embodiments of an HVAC system include a commissioning technique for applications employing a torque programmable blower motor. The compensation method determines or obtains operating parameters for an air handler system according to commanded torque and the physics of an air handler blower if available. The method is used to determine the air handler system operating parameters of blower motor such as speed as function of a given commanded torque. Specifically, the operational air flow, external static pressure are determined from measured parameters and then compared to a desired airflow for a given operation These parameters are also displayed to the installing or service technician on a smart/mobile device. Torque commands to the blower motor are then compensated with an offset or adjusted to achieve an airflow that is expected. Advantageously, employing this method, the HVAC system can be commissioned to a more optimal airflow instead of a factory set torque or speed setting that may not be optimal, nor achieve the desired airflow.

It should be noted that in a typical ducted residential HVAC system, the air handler refers to the indoor air handling unit that delivers conditioned air through air ducts to various parts of the home. In one typical system type, the indoor air handler is also referred to as the fan coil unit and includes an indoor blower and motor as well as indoor refrigerant coil to provide cooling or heating in conjunction with an outside air conditioner or heat pump unit. The air handler may also optionally include a supplemental heat source such as an electric strip heater or a hydronic hot water coil. In another typical system, the indoor air handler includes a gas furnace unit that also includes an indoor blower and motor, which is capable of delivering heat by combusting a fuel such as natural gas or propane. Embodiments apply to both types of air handler units and are directed to air delivery capabilities, the power consumption of the blower motor and the duct restriction represented by the external static pressure.

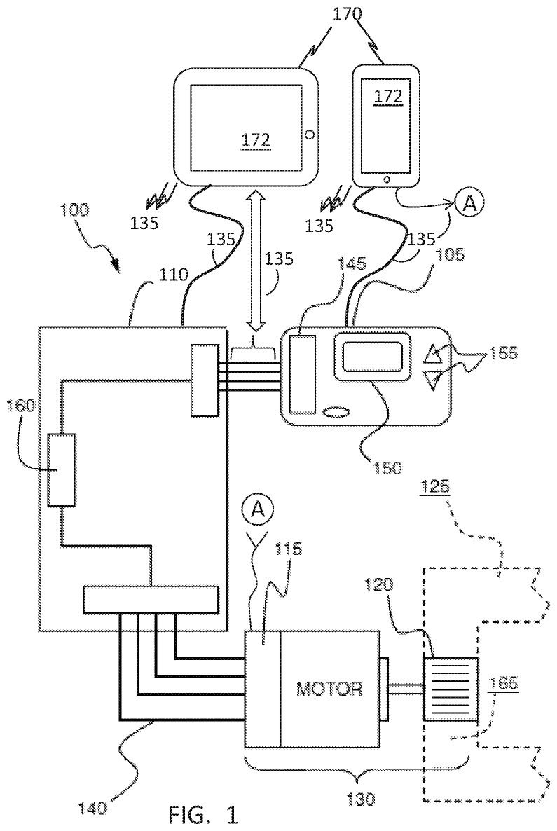

Referring now to the drawings, FIG. 1 illustrates a schematic view of an HVAC system 100. Particularly, the HVAC system 100 includes a system control unit 105, an air handler controller 110, and a blower system 130 (as part of an air handler) having a torque or speed programmable motor 115 and a centrifugal blower 120 connected to the duct system 125. The system control unit 105 may be a conventional thermostat with a display 150 indicating system status to a user and up/down selection buttons 155 to control selections for operation of the HVAC system 100. The system control unit 105 may include a processor and communications interface 145 for controlling the HVAC system and communicating with the other HVAC system 100 components. The system control unit 105 is in operative communication with the air handler controller 110 over system communication bus 135, which communicates signals between the system control unit 105 and the air handler controller 110.

In addition, user device 170 may communicate with the system 100 either via the system control unit 105, with the air handler controller 110, or directly to components such as the motor 115. The user device 170 may be any form of a mobile device (e.g., smart phone, smart watch, wearable technology, laptop, tablet, etc.). The user device 170 can include several types of devices, in one instance, even a fixed device, e.g. a keypad/touch screen affixed to a wall in a building corridor/lobby, and a user-owned device 170 such a smartphone. It should be appreciated that the first two (system control unit 105, with the air handler controller 110) are typically part of the system 100 infrastructure, while the third is typically owned and used by the service man, homeowner, and the like. The term “user device” 170 is used to denote all of these types of devices as may be employed by the user for the purposes of communication with the system 100. It should be appreciated that in some instances a user device 170 are proximate to the system 100, for example, a thermostat or system control unit 105, in others they are mobile. As a result of the bi-directional flow of information between the system control unit 105 and the air handler controller 110, and the user device 170, the algorithms described in exemplary embodiments may be implemented in either control unit 105 or controller 110, or the user device 170. Also, in some embodiments, certain aspects of the algorithms may be implemented in control unit 105 while other aspects may be implemented in controller 110, while other aspects may be implemented in the user device. For example in an embodiment, algorithms for system communication, system and temperature control may be implemented in the system control unit 105, while algorithms specifically for air handler 102 control may be implemented in the air handler controller 110, and yet algorithms for user preferences, user functions, commissioning, maintenance and diagnostics and the like might be implemented in the user device 170.

The user device 170 may include a mobile and/or personal device that is typically carried by a person, such as a phone, PDA, etc. The user device 170 may include a processor, memory, and communication module(s), as needed to facilitate operation and interfacing with the system 100. As described below, the processor can be any type or combination of computer processors, such as a microprocessor, microcontroller, digital signal processor, application specific integrated circuit, programmable logic device, and/or field programmable gate array. The memory can be a non-transitory computer readable storage medium tangibly embodied in the user device 170 including executable instructions stored therein, for instance, as firmware. The communication module may implement one or more communication protocols as described in further detail herein, and may include features to enable wired or wireless communication with external and/or remote devices separate from the user device 170. The user device 170 may further include a user interface 172 (e.g., a display screen, a microphone, speakers, input elements such as a keyboard or touch screen, etc.) as known in the art.

The user device 170, as well as other components of the system 100 including system control unit 105, with the air handler controller 110, and motor 115 may communicate with one another, in accordance with the embodiments of the present disclosure, e.g., as shown in FIG. 1. However in some embodiments it should be appreciated that the motor may not include communications with the controllers beyond receiving torque/speed setting commands setting status flags and the like. For example, one or more user devices 170 and the air handler controller 110 or system control unit 105 may communicate with one another when proximate to one another (e.g., within a threshold distance). The user device 170 and any or all of system control unit 105, with the air handler controller 110, and motor 115 may communicate over one or more networks 135, (e.g., communication bus 135) that may be wired or wireless. Wireless communication networks 135 can include, but are not limited to, Wi-Fi, short-range radio (e.g., Bluetooth®), near-field infrared, cellular network, etc. In some embodiments, the system control unit 105 or air handler controller 110 may include, or be associated with (e.g., communicatively coupled to) one or more other networked building elements (not shown), such as computers, beacons, other system controllers, bridges, routers, network nodes, etc. The networked element may also communicate directly or indirectly with the user devices 170 using one or more communication protocols or standards (e.g., through the network 175). For example, the networked element may communicate with the user device 170 using near-field communications (NFC) and thus enable communication between the user device 170 and the system control unit 105 or any other components in the system 100. The network 135 may be any type of known communication network including, but not limited to, a wide area network (WAN), a local area network (LAN), a global network (e.g. Internet), a virtual private network (VPN), a cloud network, and an intranet. The network 135 may be implemented using a wireless network or any kind of physical network implementation known in the art. The user devices 170 and/or the networked devices may be coupled to the system control unit 105, the air handler controller 110, and/or motor 115 through multiple networks 135 (e.g., cellular and Internet) so that not all user devices 170 and/or the networked devices are coupled to the any given controller or component 105, 110, 115 through the same network 135. One or more of the user devices 170 and the system control unit 105 may be connected to the network 135 in a wireless fashion. In one non-limiting embodiment, the network 135 is the Internet and one or more of the user devices 170 execute a user interface application (e.g. a web browser, mobile app) to contact the including system control unit 105, the air handler controller 110, and/or motor 115 through the network 135.

In one embodiment, the user device 170 includes a computing system having a computer program stored on nonvolatile memory to execute instructions via a microprocessor related to aspects of an air flow computations associated with the blower 120 and motor 115 in HVAC system 100. Also, the user device 170 includes a user input element 172 by which a user/installer may change the desired operating characteristics of the HVAC system 100, such as torque commands, air flow requirements and the like. The user may also enter certain specific aspects of the air handler installation such as, for example, the location or local altitude for operation of the air handler, which may be used in the various algorithms. It is to be appreciated that the system control unit 105 implements aspects of an air flow control algorithm for determining the operating parameters including air volume flow rate or air mass flow rate, the blower 120 power consumption, and duct static pressure over the operating range of the motor 115. The determination of these operating parameters through various algorithms eliminates a need to measure some parameters against published parameters, thereby potentially providing for self-certification of the HVAC system 100. In an embodiment, for example, selected operating parameters may be compared to published, expected parameters to provide a certification that the HVAC system 100 meets the published parameters. It should be appreciated that while aspects of the algorithms described may be executed in the system control unit 105, in other embodiments, any of the above algorithms may also be executed in the air handler controller 110, or elsewhere without departing from the scope of the invention.

The HVAC system 100 may include an air handler controller 110 operably connected to the blower system 130 for transmitting torque commands to the blower system 130. The air handler controller 110 includes a processor 160 and memory, which stores operational characteristics of blower system 130 that are specific to the air handler unit model being used. The operational characteristics may include blower diameter and blower operating torque. In one embodiment, air handler controller 110 transmits, over the motor communication bus 140, operation requests to the variable speed motor 115 in the form of a torque command, and receives operating speed of the motor 115 via the motor communication bus 140. It should be appreciated that the motor communication bus 140 may be the same as network 135. In addition, the user device 170 may also be directly connected to the motor communication bus 140 as may be understood in the art. The programmable torque/speed motor 115 receives operational torque commands from the air handler controller 110 directing the blower 120 to operate at the commanded motor operating torque. In some embodiments, the air handler 102 may not always include a controller 110. For example some fan coils have no control board other than the blower motor control module attached to the motor 115. In these instances the user device 170 and/or the system control unit 105 may be configured to communicate directly with the motor 115.

In some systems, for every air handler unit model, the air handler controller 110 may store a full set of characteristic constants used by various control algorithms for the HVAC system 100. Also, during the manufacturing process, information about the specific air handler unit model is also stored in the memory of the air handler controller unit 110. In some instances, these characteristic constants are pre-determined for each air handler model by characterizing tests run during the product development process for each model. In some systems this information may be stored in the user device 170. In others the data could be stored in an accessible server, a cloud based server, and the like. In one embodiment, when the air handler controller 110 or the motor 115 is a field service replacement part that has not gone through the air handler unit's manufacturing process, the service technician may need to enter the specific air handler unit model information into the system control unit 105 at the time of the field replacement. The system control unit 105 then communicates the specific air handler model information to the air handler controller 110. Knowing the specific air handler unit model, the air handler controller 110 looks up the specific characteristic constants applicable to the model from the list of constants for all possible models stored in its memory. These characteristic constants can then be used in the execution of the algorithms In an embodiment, especially with simpler air handlers 102 and motors 115, user device 170 may be employed to scan and identification code or have the user enter the model number then lookup characteristics in the app or cloud based on the model number. In operation the air handler controller 110 sends a torque/speed command to the blower motor 115 over the motor communication bus 140 or via dedicated predetermined torque/speed setting inputs. The motor operates the blower at the commanded torque to achieve the expected air flow based on the predetermined information. However, once installed, based on given ductwork restrictions, filters, or even replaced components, sometimes the commanded torque may not achieve the expected airflow. The described methodology provides a scheme for determining if an airflow discrepancy is present and for adjusting the commanded torque to achieve a desired airflow and static pressure.

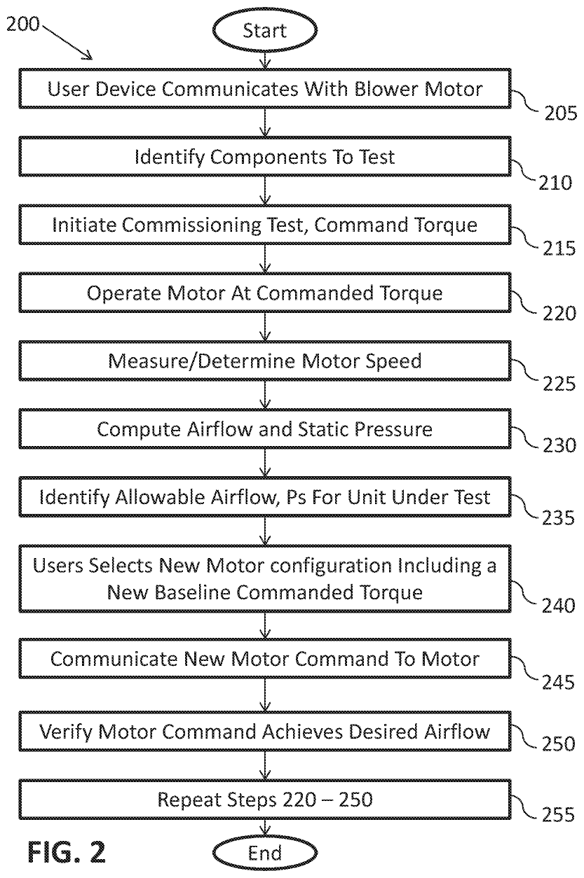

FIG. 2 depicts a flow chart of the method 200 for commissioning an HVAC system blower motor 115 to a match a ducted application in accordance with an embodiment. At process step 205, the communication is established between user device 170 and the blower motor 115. As discussed above, the communication may be via NFC, Bluetooth or wired on network 135 and/or via communication bus 140. In addition the communication could be via the system control unit 105 or the air handler controller 110. The user inputs or acquires a product model number operating on the user device 170 to identify the product as depicted at process step 210. The part could be the air handler controller, 110, blower motor 115, and fan 120 employed. Model number input may come from bar code scan, manual entry, or communication from the motor or HVAC system 100. At process step 215 the user/service person initiates a motor commissioning test via the user device 170. The testing includes the user device 170 sending a test command to the blower motor 115 including known torque setting. The motor runs an operational test at the known torque and motor speed (rpm) is measured and transmitted to the user device 170 as depicted at process steps 220 and 225. The motor speed is typically measured with a sensor internal to the motor 115, or for sensorless applications computed from the motor parameters using known techniques. However, other sensors and techniques may be employed to determine the motor speed. In some embodiments external measurements are made to determine the motor speed under the commanded torque.

At process step 230, the method 200 continues using the known commanded torque, resulting motor speed, and various product operating characteristics to calculate the associated airflow and static pressure. As described above the airflow and static pressure of the duct system is computed based on an airflow model for that model air handler 100, motor 115 and blower 120. The computation can be a function of an algorithm, approximation, or a simple look up table. The values for the airflow and static pressure may have been established during initial product development and testing for the various models of HVAC system 100 components, including motors 115 and blowers 120 as a function of commanded torque and speed. The method continues with the application operating on the user device 170 identifying the allowable airflow settings for particular model blower 120 and motor 115 being tested and calculates resulting system static pressures and power as depicted at process step 235. The possible options with static pressure and power are displayed to the installer/service person on the user device 170. The user selects a new motor configuration from the available options as depicted at process step 240. The new motor configuration includes a new airflow and the system calculates a new commanded torque to be applied to the blower motor 115 targeted at achieving the new desired airflow in view of the installed configuration. The user device 170 communicates the new motor command including a new torque setting matching desired configuration to the motor 115 as depicted at process step 245. In an embodiment, to ensure the desired airflow is achieved, a second test is conducted using the user selected torque and send the resulting motor speed back to the user device 170. The method 200 continues with employing the new known torque and resulting motor speed to calculate the associated airflow and static pressure of the duct system based on an airflow model for that model. If resulting airflow differs from the desired airflow by more than a selected allowable tolerance another new torque setting is calculated using the results of the latest test and communicated to the motor as depicted at process step 250. The process is repeated if needed as depicted at process step 255, until the airflow is within the application tolerance or a limit of operation is reached. In an embodiment it may be expected that airflow ranges for different systems may be on the order of about 200-2000 cfm. While tolerances on accuracy of the airflow could be variable. For example, in an embodiment the allowable tolerance may be on the order of +/−10% of the target cfm. Further yet tolerances may be on the order of +/−7% of target cfm. In some embodiments the tolerances may be as tight as +/−5% of target cfm. Further yet, in some systems exhibiting higher performance tolerances on the order of +/−2% of target or +/−1% of target cfm may be achievable.

Once a final torque command setting is determined, it is stored in memory in the motor 115. In an embodiment, the revised motor command settings are also communicated to and stored in the system control 105 and/or the controller for the air handler 110. In another embodiment, the control 110 or 105 could store the values and simply send pulse-width modulation (PWM) signals to the motor 115. The motor would not need to store torques.

The technical effects and benefits of embodiments relate to an HVAC system include a system control unit or user device or implementing an internal compensation algorithm to determine operating parameters for an air handler system. The algorithm is used to determine the air handler system operating parameters of indoor air flow volume, indoor air mass flow, external static pressure in a duct system, and blower motor power consumption, including consumption at altitudes. An accurate determination of these parameters permits the ability to customize airflow based on the application without the need for a variable speed blower.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for commissioning an air handler including an indoor blower and a motor to match a ducted application in a heating, ventilation, and cooling (HVAC) system, comprising:
obtaining product and operational information regarding at least one HVAC system components including the motor and the blower;
communicating a commanded torque to the motor;
operating the motor at the commanded torque;
receiving a motor signal indicative of an operating characteristic of the motor; and
determining at least an operational air flow based on at least the commanded torque, the operating characteristic, and the operational information;
comparing an operational air flow to a desired airflow for a particular configuration of the HVAC system based on the operational information; and
identifying and communicating a new commanded torque to the motor if the difference between the operational airflow and the desired airflow exceeds a selected tolerance.

2. The method of claim 1, further comprising iteratively repeating the communicating a commanded torque, operating, receiving, determining, comparing, and identifying steps periodically if the difference between the operational airflow and the desired airflow exceeds the selected tolerance.

3. The method of claim 1, wherein the communicating with the motor includes transmitting and receiving information via a user device on at least one of a motor control bus, a system control bus, a wired system network, and a wireless system network.

4. The method of claim 3, wherein the torque command is transmitted via at least one of an air handler controller in operable communication with at least one of the motor, the user device, and the system control unit; a user device in operable communication with at least one of the motor, the air handler controller and the system controller; and a system control unit in operable communication with at least one of the air handler controller, the user device, and the motor.

5. The method of claim 1, wherein the obtaining product and operational information includes at least one of: type of motor, type of blower, motor model, blower model, motor size, motor operational constraints, and blower operational constraints.

6. The method of claim 1, wherein the receiving a motor signal comprises receiving the signal at a user device in operable communication with at least one of the system controller, the air handler controller, and the motor.

7. The method of claim 1 wherein the operating characteristic is indicative of the rotational speed of the motor.

8. The method of claim 1, further comprising displaying at least one of the operating characteristic and operational information of the motor.

9. The method of claim 1, wherein the determining the operational air flow is identified by at least one of a signal provided by the motor, a look up table, and equation or formula.

10. The method of claim 1, wherein determining the operational air flow includes comparing the operational airflow to expected parameters to provide a certification of the air handler.

11. The method of claim 1, wherein the desired airflow is based on previously established testing and empirical data for a given air handler configuration.

12. The method of claim 1, wherein the selected tolerance is at least one of: of +/−10% of the target airflow, +/−7% of target airflow, +/−5% of target airflow, +/−2% of target airflow, and +/−1% of target airflow.

13. A system for commissioning an air handler to match a ducted application in a heating, ventilation, and cooling (HVAC) system, comprising:
an air handler including an indoor blower and a motor operably coupled to a duct network, the motor configured to operate at a preset torque;
a user device in operable communication with the motor, user device configured to execute a method for commissioning the air handler, comprising:
obtaining product and operational information regarding the HVAC system components including the motor and the blower;
communicating a commanded torque to the motor;
operating the motor at the commanded torque;
receiving a motor signal indicative of an operating characteristic of the motor; and
determining at least an operational air flow based on at least the commanded torque, the operating characteristic, and the operational information;
comparing an operational air flow to a desired airflow for a particular configuration of the HVAC system based on the operational information; and
identifying and communicating a new commanded torque to the motor if the difference between the operational airflow and the desired airflow exceeds a selected tolerance.

14. The system of claim 13, wherein the method further includes iteratively repeating the communicating a commanded torque, operating, receiving, determining, comparing, and identifying and communicating steps periodically if the difference between the operational airflow and the desired airflow exceeds the selected tolerance.

15. The system of claim 13, further including at least one of an air handler controller in operable communication with at least one of the motor and the user device, the air handler controller configured to provide control commands to operate the motor; and a system control unit, the system control unit in operable communication with at least one of the motor, the air handler control unit, and the user device, at least one of the air handler controller and system controller configured to execute the method for commissioning the air handler.

16. The system of claim 14 further including the torque command being transmitted via at least one of an air handler controller in operable communication with the motor, and a system control unit in operable communication with at least one of the air handler controller and the motor.

17. The system of claim 13, wherein the user device communicating with the motor via a on at least one of a motor control bus, a system control bus, a wired system network, and a wireless system network.

18. The system of claim 13, wherein the product and operational information includes at least one of: type of motor, type of blower, motor model, blower model, motor size, motor operational constraints, and blower operational constraints.

19. The system of claim 13, wherein the receiving a motor signal comprises receiving the signal at a user device in operable communication with at least one of the system controller, the air handler controller, and the motor.

20. The system of claim 13 wherein the operating characteristic is indicative of the rotational speed of the motor.

21. The system of claim 13, further comprising displaying at least one of the operating characteristic and operational information of the motor.

22. The system of claim 13, wherein the determining the operational air flow is identified by at least one of a signal provided by the motor, a look up table, and equation or formula.

23. The system of claim 13, wherein determining the operational air flow includes comparing the operational airflow to expected parameters to provide a certification of the air handler.

24. The system of claim 13, wherein the desired airflow is based on previously established testing and empirical data for a given air handler configuration.

25. The system of claim 13 wherein the selected threshold is at least one of: wherein the selected tolerance is at least one of: of +/−10% of the target airflow, +/−7% of target airflow, +/−5% of target airflow, +/−2% of target airflow, and +/−1% of target airflow.
